(19) United States
(12) Patent Application Publication
(10) Pub. No.: US 2025/0163647 A1
(43) Pub. Date: May 22, 2025

(54) METHOD FOR PRODUCTION OF VINYL CARBOXAMIDE CONTAINING POLYMERS IN PARTICULATE FORM

(71) Applicant: SOLENIS TECHNOLOGIES, L.P., Wilmington, DE (US)

(72) Inventors: Christian Dollendorf, Neuss (DE); Shantanu P. Nikam, Wilmington, DE (US); Sachin Borkar, Wilmington, DE (US)

(73) Assignee: SOLENIS TECHNOLOGIES, L.P., Wilmington, DE (US)

(21) Appl. No.: 18/954,642

(22) Filed: Nov. 21, 2024

Related U.S. Application Data
(60) Provisional application No. 63/601,855, filed on Nov. 22, 2023.

(51) Int. Cl. D21H 17/34; C08F 126/02; D21H 21/10

(52) U.S. Cl. CPC D21H 17/34; C08F 126/02; D21H 21/10

(57) ABSTRACT

Provided is a method for the production of vinylcarboxamide-containing polymers or co-polymers in granular, beaded, powdered, or particulate form and their subsequent hydrolysis. The vinylcarboxamide-containing polymers or co-polymers are produced via a polymerization process employing a photoinitiated gel polymerization technique.

### CROSS-REFERENCE TO RELATED APPLICATIONS

This application claims the benefit of U.S. Provisional application No. 63/601,855, filed 22 Nov. 2023, the entire contents of which are hereby incorporated by reference.

### TECHNICAL FIELD

Provided is a method for production of vinyl carboxamide containing polymers in a granular, beaded, powdered, or particulate form. The method relates to production of poly(N-vinyl formamide), or its co-polymer in a granular, beaded, powdered, or particulate form employing photoinitiated gel polymerization technique followed by the removal of the aqueous medium. The product can then be transported to a customer site for hydrolysis.

### BACKGROUND

Polyvinylamine (PVAM) and its compositions are commonly used in the manufacture of paper, board, or the like. These polymers are typically manufactured through the hydrolysis of polyvinylcarboxamide polymers, such as polyvinylformamide or its copolymers. However, delivering chemicals, such as PVAM or polyvinylformamide (PVFA) polymers to customers, involve high transportation and storage costs due to the large volumes involved. Today, commercial products have actives/solid content generally ranging from about 5 weight % (wt. %) to about 50 wt. %. A PVAM/PVFA product in a granular, beaded, powdered, or particulate form would help transport larger quantities of active polymer.

The molecular weight (Mw) of the PVAM backbone was found to be an important parameter for its performance in the manufacture of paper and paperboard. The long backbone provides sufficient dimensions for bonding and linkages between the fiber surfaces. The good formation, bonding ability and excellent dewatering provided by the PVAM polymer are beneficial for their strength properties of the final paper or board.

In general, higher molecular weight PVAMs provide a higher performance boost and faster production. The currently employed polymerization methods are limited in their ability to achieve molecular weights while keeping the reactant residuals low. Current invention allows for production of polymers with higher molecular weight and about 100% solids content. These polymers show excellent de-watering performance and strength properties to the paper when compared to polymers in the prior art. The faster dewatering allows for the energy savings in the dryer section and a faster rate of production.

However, the polymer formulations currently in use have inherent limitations in the form of shelf-life, transportation, and in most cases, molecular weight. In general, it has been found that the higher molecular weight PVAMs provide higher performance boost and faster production speeds.

A higher molecular weight PVAM could have even higher benefits. However, with increasing molecular weight, at optimum reaction solids, the viscosity of the aqueous reaction mixture made with conventional techniques increase rapidly making it difficult to handle. Therefore, in order to achieve higher molecular weights with the conventional techniques, the products need to be produced at progressively lower actives/solid content. Thus, increasing the transportation cost involved with shipping of less concentrated products. This makes the operation inefficient and economically less viable and also increase the carbon footprint associated with the product.

The current method relates to production of poly(N-vinyl formamide), or its co-polymer in a solid bead/powder/granule/particulate form employing a photoinitiated gel polymerization technique. The product can then be transported to a customer site where it will be hydrolyzed in solution.

Though PVAM and its compositions are fairly stable, the PVFA polymers tend to be more stable over extended periods of time. Employing an on-site hydrolysis will allow on-demand hydrolysis of more stable PVFA, thus further enhancing the shelf-life of the product.

Typically, PVFA is produced via radical solution polymerization with lower temperatures or under reduced pressure to avoid several side reactions that typically occur at elevated temperatures. These side reactions lead to unwanted products that may interfere with the polymerization and may cause crosslinking in the subsequent hydrolysis step to produce PVAM. The current invention allows for control of temperature profile of the aqueous medium during polymerization by controlling the LED intensity (see FIG. 1). For example, at lower intensity, initiator decomposition is slowed and thus polymerization rate is lowered, resulting in slower temperature increase, or even steady temperature.

The current invention uses LED for UV light source as it emits light with narrow wavelength spectrum allowing for a more energy efficient process.

The present method of providing a vinylcarboxamide containing polymer in a granular, beaded, powdered, or particulate form would minimize or eliminate the disadvantages associated with the transportation, molecular weight, and performance issues of current methods.

The present disclosure will hereinafter be described in conjunction with the following drawing figures.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a method for producing a composition containing an N-vinylcarboxamide-containing polymer that includes polymerizing through photoinitiated gel polymerization of a formulation containing a N-vinylcarboxamide monomer.

The method includes the polymerization of an aqueous solution that includes one or more N-vinylcarboxamide monomer(s) of Formula I;

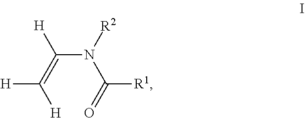

in which R¹ and R², independently of one another, are H or C₁ to C₆ alkyl. Optionally, the gel polymerization can be performed with one or more additional vinyl monomer(s) which are different from Formula I.

The product produced by the photoinitiated gel polymerization is formed into a polymer gel and the water from the produced polymer gel is removed through any typical drying means.

The dry polymer product can then be hydrolyzed as needed. For example, the product can be transported and hydrolyzed in an aqueous solution of base(s) or acid(s), at a remote location.

Also provided is a granular, beaded, powdered, or particulate composition produced by the polymerization process described above.

### BRIEF DESCRIPTION OF THE DRAWINGS

The present disclosure will hereinafter be described in conjunction with the following drawing figures:

FIG. 1, shows the temperature profile of the aqueous medium during polymerization.

FIG. 2, shows results of drainage tests reported in seconds and plotted against dosage expressed in lb/T.

### DETAILED DESCRIPTION

The following detailed description is merely exemplary in nature and is not intended to limit the invention or the application and uses of the invention. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

The term “active solids” used for the polymer of the present composition herein represents the total weight of the polymer as a percentage of a solution of all the monomers and modifying compounds used for making the polymer on dry weight basis. The term “mole percent” of a monomer in a polymer refers to percentage of specific monomer present in the polymer as a repeating unit. The term “weight percent” or “weight ratio” of a material used in the present invention represents the percentage or the ratio of the “active solids” of this material versus other components.

As used herein, the term “paper” refers to paper products including tissue paper, paper towels and paper board.

Provided is a method of producing a composition of a N-vinylcarboxamide-containing polymer using photoinitiated gel polymerization. The method includes performing a photoinitiated gel polymerization of an aqueous phase using initiators that are only sensitive to UV light and wherein the suspension contains:

one or more N-vinylcarboxamide monomer(s) of Formula I,

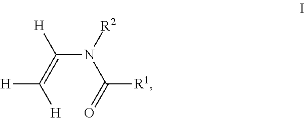

wherein R¹ and R², independently of one another, are H or C₁ to C₆ alkyl; and optionally, one or more vinyl monomer(s) which are different from Formula I. The resulting polymer gel is cut, and water is removed from the polymerized product whereby a dry N-vinylcarboxamide-containing polymer is obtained.

In the current process, the gel is cut and then dried, either conventionally or with a fluid bed dryer and then the dry polymer is ground to a desired particle size.

Another drying method, is the belt process in which the gel is moving on a belt through different drying zones, with typical drying times taking up to 90 minutes.

In some aspects of the method, the initiator can be chosen from 2-hydroxy-2-methylpropiophenone, 2,2′-azobis-(2-methyl-propionamidin)-dihydrochloride, 2,2′-azobis(2-methylpropionitrile), 2,2′-azobis[2-(2-imidazolin-2-yl)propane]dihydrochloride or comparable azo initiators, 2,2-dimethoxy-2-phenylacetophenone, alpha-ketoglutaric acid, camphorquinone, (1-hydroxycyclohexyl)-phenyl ketone, α-Hydroxy-4-(2-hydroxyethoxy)-α-methylpropiophenone, ethyl 2-oxopropanoate, ethyl 3-methyl-2-oxabutanoate, 4,4-dimethyldihydrofurane-2,3-dione, ethyl phenylglyoxylate, and combinations thereof.

In yet other aspects of the method, the initiator can be 2-hydroxy-2-methylpropiophenone.

In other aspects of the method, the photoinitiated gel polymerization is carried out using one or more radical co-initiators.

In other aspects of the method, the radical co-initiator can be for example, methyldiethanolamie.

In yet other aspects of the method, the radical co-initiators are selected from, for example peroxides, hydroperoxides, so-called redox catalysts or azo compounds which decompose into radicals. Examples for peroxides are alkali or ammonium peroxide sulfates, diacetyl peroxide, dibenzoyl peroxide, succinyl peroxide, di-tert-butyl peroxide, tert-butyl perbenzoate, tert-butyl perpivalate, tert-butyl peroxy-2-ethyl hexanoate, tert-butyl peroxy-2-ethyl hexanoate butyl permaleinate, cumene hydroperoxide, diisopropyl peroxidicarbamate, bis(o-toluoyl) peroxide, didecanoyl peroxide, dioctanoyl peroxide, dilauroyl peroxide, tert-butyl perisobutyrate, tert-butyl peracetate or di-tert-amyl peroxide. An example for hydroperoxide is tert-butyl hydroperoxide. Examples for azo compounds that decompose into radicals are azo-bis-isobutyronitrile, azo-bis-(2-amidonopropane)dihydrochloride, 4,4′-azobis(4-cyanovaleric acid), 2,2′-azobis[2-methyl-N-(2-hydroxyethyl)propionamide], 2,2′-azobis(2-methylpropionamidine)dihydrochloride, 2,2′-Azobis[2-(2-imidazolin-2-yl)propane]dihydrochloride, 2,2′-azobis[N-(2-carboxyethyl)-2-methylpropionamidine]tetrahydrate, 2,2′-azobis[2-(2-imidazolin-2-yl)propane] or 2-2′-azo-bis-(2-methyl-butyronitrile). Examples for so-called redox catalysts are ascorbic acid/ferrous (II) sulfate/sodium peroxodisulfate, tert-butyl hydroperoxide/sodium disulfite, tert-butyl hydroperoxide/sodium hydroxy methane sulfinate, H₂O₂/CuI and combinations thereof.

In some aspects of the method, the polymerization is initiated using a UV light source, such as a UV-LED light, having an emission wavelength of from about 300 nm to about 400 nm, or from about 350 nm to about 360 nm.

In other aspects of the method, the intensity of the UV light source, such as a UV-LED light source, is from about 55 μW/cm² to about 40000 μW/cm², or from about 250 μW/cm² to about 10000 μW/cm².

In other aspects of the method, the initial temperature of the gel polymerization reaction is from about −5° C. to about 50° C., or from about 0° C. to about 25° C.

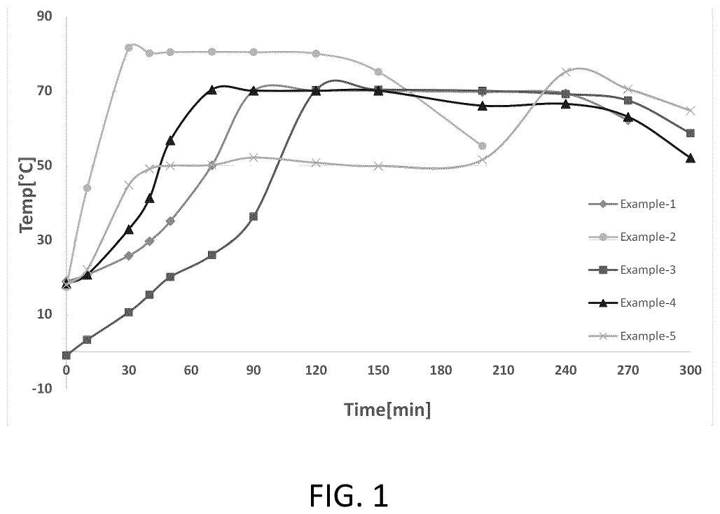

In some aspects of the method, the temperature profile of the aqueous medium during polymerization is from 0° C. to about 90° C., or from about 0° C. to about 70° C., or from about 50° C. to about 70° C., wherein the temperature is controlled via LED intensity (see FIG. 1). At lower LED intensity, initiator decomposition and degree of polymerization is lowered. In addition, the reaction temperature of the polymerization can be controlled using the intensity of the UV light resulting in a slow and steady temperature increase thus avoiding side reactions that typically occur at elevated temperatures.

In some aspects of the method, the starting aqueous phase contains monomer(s) in an amount from about 5 wt. % to about 80 wt. % or from about 35 wt. % to about 60 wt. % based on total weight of the aqueous phase.

In some aspects of the method, the N-vinylcarboxamide-containing polymer has a molecular weight in the range of from about 5,000 Daltons to about 5,000,000 Daltons, or from about 100,000 Daltons to about 2,000,000 Daltons, or from about 250,000 Daltons to about 750,000 Daltons.

In other aspects of the method, the water is removed or partially removed from the polymerized product through drying from about 50° C. to about 150° C., or from 60° C. to about 80° C., for about 20 minutes to about 300 minutes, either via conventional drying or air drying. The final water content of the N-vinylcarboxamide-containing polymer can be adjusted to have any water content desired, but typically will be from 0 wt. % to about 15 wt. % or from about 0 wt. % to about 10 wt. %.

In some aspects of the method, the N-vinylcarboxamide monomer is selected from N-vinylformamide, N-vinyl-N-methylformamide, N-vinylacetamide, N-vinyl-N-methylacetamide, N-vinyl-N-ethylacetamide, N-vinylpropionamide, N-vinyl-N-methyl-propionamide, N-vinylbutyramide, copolymers of N-vinylformamide and combinations thereof.

Vinyl monomer refers to monomers which have (H₂C═C—) groups in their structure. Vinyl monomers could alternatively be defined as ethylenically unsaturated monomers. An ethylenically unsaturated monomer herein is a monomer containing at least one C₂ unit whose two carbon atoms are linked by a carbon-carbon double bond. In the case of hydrogen atoms as the only substituent, this is ethylene. In the case of substitution with three hydrogen atoms, a vinyl derivative is present. In the case of substitution with two hydrogen atoms, an E/Z isomer, or an ethene-1,1-diylderivative is present. Mono-ethylenically unsaturated monomer means here that exactly one C₂ unit is present in the monomer.

In some aspects of the method, a cationically charged group of a given monomer or class of monomers, salt form means that a corresponding anion ensures charge neutrality. Such anions are for example chloride, bromide, hydrogen sulfate, sulfate, hydrogen phosphate, methyl sulfate, acetate, or formate.

In some aspects of the method, wherein an anionically charged group of a specified monomer or class of monomers, a salt form means that a corresponding cation ensures charge neutrality. Some cations can be, for example cations of the alkali metals, alkaline earth metals, ammonia, alkylamines or alkanolamines, such as Li⁺, Na⁺, K⁺, Rb⁺, Cs⁺, Mg²⁺, Ca²⁺, Sr²⁺, Ba²⁺ and NH⁴⁺.

In some aspects of the method, the vinyl monomer(s) is/are selected from monoethylenically unsaturated carboxylic acids and salts thereof, monoethylenically unsaturated C₃-C₈ mono- or dicarboxylic acids and salts thereof. Examples are acrylic acid, sodium acrylate, methacrylic acid, sodium methacrylate, dimethacrylic acid, crotonic acid, maleic acid, fumaric acid, itaconic acid, mesaconic acid, citraconic acid, methylene malonic acid, allylacetic acid, vinyl acetic acid, crotonic acid, and combinations thereof.

In some aspects of the method, the vinyl monomer(s) is/are chosen from monoethylenically unsaturated sulfonic acids and their salt forms, vinyl sulfonic acids and their salt forms such as, vinyl phosphonic acid, allyl sulfonic acid, acrylamido-2-methylpropane sulfonic acid, methacrylamido-2-methylpropane sulfonic acid, allylsulfonic acid, methallysulfonic acid, sulfoethyl acrylate, sulfoethyl methacrylate, sulfopropyl acrylate, sulfopropyl methacrylate, 2-hydroxy-3-methacryloxypropyl sulfonic acid, allyl phosphonic acid, styrene sulfonic acid, 2-acrylamido-2-methylpropanesulfonic acid, and combinations thereof.

In some aspects of the method, the vinyl monomer(s) can be chosen from monoethylenically unsaturated phosphonic acids and their salt forms, for example, vinylphosphonic acid, vinylphosphonic acid monomethyl ester, allylphosphonic acid, allylphosphonic acid monomethyl ester, acrylamidomethylpropyl phosphonic acid, acrylamidomethylene phosphonic acid, and combinations thereof.

In other aspects of the method, the vinyl monomer(s) can be selected from monoesters of α,β-ethylenically unsaturated monocarboxylic acids with C₁-C₃₀ alkanols, monoesters of α,β-ethylenically unsaturated monocarboxylic acids with C₂-C₃₀ alkanediols, diesters of α,β-ethylenically unsaturated dicarboxylic acids with C₁-C₃₀ alkanols or C₂-C₃₀ alkanediols, primary amides of α,β-ethylenically unsaturated monocarboxylic acids, N-alkylamides of α,β-ethylenically unsaturated monocarboxylic acids, N,N-dialkylamides of α,β-ethylenically unsaturated monocarboxylic acids, nitriles of α,β-ethylenically unsaturated monocarboxylic acids, dinitriles of α,β-ethylenically unsaturated dicarboxylic acids, esters of vinyl alcohol with C₁-C₃₀ monocarboxylic acids, esters of allyl alcohol with C₁-C₃₀ monocarboxylic acids, N-vinyl lactams, nitrogen-free heterocycles with an α,β-ethylenically unsaturated double bond, vinyl aromatics, vinyl halides, vinylidene halides, C₂-C₈ mono-olefins or C₄-C₁₀ olefins with exactly two double bonds that are conjugated, and combinations thereof.

In some aspects of the method, monoesters of α,β-ethylenically unsaturated monocarboxylic acids with C₁-C₃₀ alkanols can be chosen from, for example, methyl acrylate, methyl methacrylate, methyl ethacrylate (methyl 2-ethyl acrylate), ethyl acrylate, ethyl methacrylate, ethyl ethacrylate (ethyl 2-ethyl acrylate), n-butyl acrylate, n-butyl methacrylate, isobutyl acrylate, isobutyl methacrylate, tert-butyl acrylate, tert-butyl methacrylate, tert-butyl ethacrylate, n-octyl acrylate, n-octyl methacrylate, 1,1,3,3-tetramethyl butyl acrylate, 1,1,3,3-tetramethyl butyl methacrylate, 2-ethylhexyl acrylate, and combinations thereof.

In other aspects of the method, the monoesters of α,β-ethylenically unsaturated monocarboxylic acids with C₂-C₃₀ alkanediols can be chosen from, for example, 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutylacrylate, 3-hydroxybutyl methacrylate, 4-hydroxybutylacrylate, 4-hydroxybutyl methacrylate, 6-hydroxyhexyl acrylate, 6-hydroxyhexyl methacrylate, and combinations thereof.

In other aspects of the method, the primary amides of α,β-ethylenically unsaturated monocarboxylic acids can be chosen from, for example, acrylic acid amide, methacrylic acid amide, or a combination thereof.

In still other aspects of the method, N-alkyl amides of α,β-ethylenically unsaturated monocarboxylic acids can be chosen from, for example, N-methylacrylamide, N-methylmethacrylamide, N-isopropylacrylamide, N-isopropylmethacrylamide, N-ethyl acrylamide, N-ethyl methacrylamide, N-(n-propyl)acrylamide, N-(n-propyl)methacrylamide, N-(n-butyl)acrylamide, N-(n-butyl)methacrylamide, N-(tert-butyl)acrylamide, N-(tert-butyl)methacrylamide, N-(n-octyl)acrylamide, N-(n-octyl)methacrylamide, N-(1,1,3,3-tetramethylbutyl)acrylamide, N-(1,1,3,3-tetramethylbutyl)methacrylamide, N-(2-ethylhexyl)acrylamide, N-(2-ethylhexyl-methacrylamide and combinations thereof.

In other aspects of the method, N,N-dialkylamides from α,β-ethylenically unsaturated monocarboxylic acids can be, for example, N,N-dimethylacrylamide, N,N-dimethylmethacrylamide, and combinations thereof.

In other aspects of the method, nitriles from α,β-ethylenically unsaturated monocarboxylic acids can be, for example, acrylonitrile, methacrylonitrile.

In yet other aspects of the method, esters of vinyl alcohol with C₁-C₃₀ monocarboxylic acids can be, for example, vinyl formate, vinyl acetate, vinyl propionate, and combinations thereof.

In other aspects of the method, N-vinyl lactams can be chosen from, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, and combinations thereof.

In other aspects of the method, vinyl aromatics can be, for example, styrene, methylstyrene and combinations thereof. Vinyl halides can be, for example, vinyl chloride, vinyl fluoride, or a combination thereof. Vinylidene halides can be, for example, vinylidene chloride, vinylidene fluoride, and combinations thereof.

In other aspects of the method, C₂-C₈ monoolefins can be, for example, ethylene, propylene, isobutylene, 1-butene, 1-hexene, 1-octene, C₄-C₁₀ olefins with exactly two double bonds that are conjugated, such as butadiene or isoprene, and combinations thereof.

In other aspects of the method the vinyl monomer(s) is/are selected from monoethylenically unsaturated monomer which carries at least one secondary or tertiary amino group and wherein at least one secondary or tertiary amino group is protonated at pH value 7, but which does not carry a group which is deprotonated at pH value 7, or salt form thereof, for example esters of α,β-ethylenically unsaturated monocarboxylic acids with amino alcohols, mono- and diesters of α,β-ethylenically unsaturated dicarboxylic acids with amino alcohols, amides of α,β-ethylenically unsaturated monocarboxylic acids with dialkylated diamines, N-vinylimidazole, vinylpyridine, and combinations thereof.

In some aspects of the method, the vinyl monomer(s) is/are selected from a monoethylenically unsaturated monomer having a quaternized nitrogen as the sole charge bearing group at a pH value of 7, or a salt form of an N-alkyl-N′-vinylimidazolium, a salt form of an N-alkylated vinylpyridinium, a salt form of an acrylamidoalkyl trialkylammonium, or a salt form of a methacrylamidoalkyl trialkylammonium. For example, a salt form of an N-alkyl-N′-vinylimidazolium can be 1-methyl-3-vinylimidazol-1-ium chloride, 1-methyl-3-vinylimidazol-1-ium methyl sulfate or 1-ethyl-3-vinylimidazol-1-ium chloride. For example, a salt form of an N-alkylated vinylpyridinium is 1-methyl-4-vinylpyridin-1-ium chloride, 1-methyl-3-vinylpyridin-1-ium chloride, 1-methyl-2-vinylpyridin-1-ium chloride or 1-ethyl-4-vinylpyridin-1-ium chloride. For example, a salt form of an acrylamidoalkyl trialkylammonium is acrylamidoethyl trimethylammonium chloride (trimethyl-[2-(prop-2-enoylamino)ethyl]ammonium chloride), acrylamidoethyl diethylmethylammonium chloride (diethyl methyl-[3-(prop-2-enoylamino)ethyl]ammonium chloride), acrylamidopropyl trimethylammonium chloride (trimethyl-[3-(prop-2-enoylamino)propyl]ammonium chloride) or acrylamidopropyl diethylmethylammonium chloride (diethyl methyl-[3-(prop-2-enoylamino)propyl]ammonium chloride). For example, a salt form of a methacrylic alkyl trialkylammonium is methacrylamidoethyl trimethylammonium chloride (trimethyl-[2-(2-methylprop-2-enoylamino)ethyl]ammonium chloride), methacrylamidoethyl diethylmethylammonium chloride (diethyl-methyl-[3-(2-methylprop-2-enoylamino)ethyl]ammonium chloride), methacrylamidopropyl trimethylammonium chloride (trimethyl-[3-(2-methyl¬prop-2-enoylamino)propyl]ammonium chloride), methacrylamidopropyl diethylmethylammonium chloride (diethyl methyl-[3-(2-methylprop-2-enoylamino)propyl]ammonium chloride).

In some aspects of the method, the vinyl monomer(s) is/are selected from diallyl-substituted amine which has exactly two ethylenic double bonds and is quaternized or protonated at pH 7, or the salt form thereof, for example, diallylamine, methyldiallylamine, diallyldipropylammonium chloride, diallyldibutylammonium chloride and combinations thereof.

In some aspects of the method the vinyl monomer(s) is/are selected from diallyl dimethylammonium chloride, diallyl diethylammonium chloride, or a combination thereof.

In some aspects of the method the vinyl monomer(s) is/are selected from tetraallylammonium chloride, triallylamine, methylenebisacrylamide, glycol diacrylate, glycol dimethacrylate, glycerol triacrylate, pentaerythritol triallyl ether, N,N-divinylethylene urea, tetraallylammonium chloride, polyalkylene glycols esterified at least twice with acrylic acid, methacrylic acid, polyols such as pentaerythritol, sorbitol, and glucose, and combinations thereof.

In some aspects of the method the vinyl monomer(s) can be selected from zwitterionic monomers with phosphobetaine, sulphobetaine, or carboxybetaine functionalities in their structure.

In other aspects of the method, the vinyl monomer(s) can be selected from sulfobetaine 3-(dimethyl(methacryloylethyl)ammonium)propane sulfonate, the sulfobetaine 3-(2-methyl-5-vinylpyridine)propane sulfonate, the carboxy betaine N-3-methacrylamidopropyl-N,N-dimetyl-beta-ammonium propionate, the carboxy betaine N-2-acrylamidoethyl-N,N-dimethyl-beta-ammonium propionate, 3-vinylimidazole-N-oxide, 2-vinyl-pyridine-N-oxide, 4-vinyl-pyridine-N-oxide, and combinations thereof.

In some aspects of the method, the acid component of the esters of α,β-ethylenically unsaturated monocarboxylic acids with amino alcohols can be acrylic acid or methacrylic acid. The amino alcohols can be, for example, C₂-C₁₂ amino alcohols, may be C₁-C₈ mono- or C₁-C₈ dialkylated at the amine nitrogen. Examples are dialkylaminoethyl acrylates, dialkylaminoethyl methacrylates, dialkylaminopropyl acrylates or dialkylaminopropyl methacrylates. Individual examples are N-methylaminoethyl acrylate, N-methylaminoethyl methacrylate, N,N-dimethylaminoethyl acrylate, N,N-dimethylaminoethyl methacrylate, N,N-diethylaminoethyl acrylate, N,N-diethylaminoethyl methacrylate, N,N-dimethylaminopropyl acrylate, N,N-dimethylaminopropyl methacrylate, N,N-diethylaminopropyl acrylate, N,N-diethylaminopropyl methacrylate, N,N-dimethylaminocyclohexyl acrylate, and N,N-dimethylaminocyclohexyl methacrylate.

In some aspects of the method, the acid component in the mono- and diesters of α,β-ethylenically unsaturated dicarboxylic acids with amino alcohols can be fumaric acid, maleic acid, monobutyl maleate, itaconic acid, crotonic acid, and combinations thereof. The amino alcohols can be C₂-C₁₂ amino alcohols, and may be C₁-C₈ mono- or C₁-C₈ dialkylated at the amine nitrogen.

In some aspects of the method, amides of α,β-ethylenically unsaturated monocarboxylic acids with dialkylated diamines can be, for example, dialkylaminoethylacrylamides, dialkylaminoethylmethacrylamides, dialkylaminopropylacrylamides, dialkylaminopropyl acrylamides and combinations thereof.

In some aspects of the method, the amides can be N-[2-(dimethyl-amino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(di-methylamino)butyl]acrylamide, N-[4-(dimethylamino)butyl]methacrylamide, N-[2-(diethylamino)-ethyl]acrylamide, N-[2-(diethylamino)ethyl]methacrylamide, and combinations thereof.

In some aspects of the method, the one or more of the optional vinyl monomers are chosen from acrylamide, methacrylamide, N-isopropylacrylamide, N-methylmethacrylamide, N-vinylpyrrolidone, acrylonitrile, vinyl acetate, vinyl chloride, styrene, quaternary ammonium salts of dimethylaminoethyl acrylate (DMAEA), quaternary ammonium salts of dimethylaminoethyl methacrylate (DMAEMA), diallyldimethylammonium chloride (DADMAC), acrylamidopropyltrimethyl ammonium chloride (APTAC), methacrylamidopropyltrimethyl ammonium chloride (MAPTAC); and/or one or more monomers from, acrylic acids, methacrylic acids, itaconic acids, crotonic acids, maleic acids, fumaric acids, 2-acrylamido 2-methylpropane sulfonic acids, vinyl sulfonic acids, vinyl phosphonic acids, allyl sulfonic acids, allyl phosphonic acids, styrene sulfonic acids, water-soluble salts of an alkali metal, water-soluble salts of an alkaline-earth metal, water-soluble salts of ammonium of these monomers, and combinations thereof.

In other aspects of the method, the composition of N-vinylcarboxamide-containing polymer is in the form of granules, beads, powder, or particulate form.

In other aspects of the method, the N-vinylcarboxamide containing polymer is hydrolyzed to a vinylamine containing polymer in an aqueous solution of base(s) or acid(s).

In other aspects of the method, the base denotes an alkali hydroxides, alkali-metal hydroxides, alkaline-earth metal hydroxides, or mixtures thereof.

In some aspects of the method, the N-vinylamine-containing polymer is shipped to a customer location, such as a papermaking plant, and the hydrolysis is carried out at the production site to produce an N-vinylamine-containing polymer.

In other aspects, the N-vinylamine-containing polymer composition described above is added to a pulp suspension in an amount of from about 0.01 wt. % to about 5.0 wt. % based on the dry content of the pulp suspension to produce paper, board, or tissue products.

In yet other aspects, the N-vinylamine-containing polymer can be added to a papermaking process as a dry strength and/or dewatering agent, a coagulant, a flocculant, a retention aid, or a sizing promoter.

Also provided is a vinylamine-containing polymer produced by performing a photoinitiated gel polymerization of an aqueous phase using initiators that are only sensitive to UV light and wherein the suspension contains:

one or more N-vinylcarboxamide monomer(s) of Formula I,

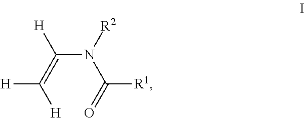

wherein R¹ and R², independently of one another, are H or C₁ to C₆ alkyl; and optionally, one or more vinyl monomer(s) which are different from Formula I. The N-vinylamine-containing polymer is then dried by any conventional means, such as a fluid bed dryer, producing a granular, beaded, powdered, or particulate form.

In some aspects of the vinylamine-containing polymer, the vinylamine-containing polymer is a solid N-vinylcarboxamide-containing polymer

In some aspects of the vinylamine-containing polymer, the initiator used in the polymerization process can be chosen from 2-hydroxy-2-methylpropiophenone, 2,2′-azobis-(2-methyl-propionamidin)-dihydrochloride, 2,2′-azobis(2-methylpropionitrile), 2,2′-azobis[2-(2-imidazolin-2-yl)propane]dihydrochloride or comparable azo initiators, 2,2-dimethoxy-2-phenylacetophenone, alpha-ketoglutaric acid, camphorquinone, (1-hydroxycyclohexyl)-phenyl ketone, α-hydroxy-4-(2-hydroxyethoxy)-α-methylpropiophenone, ethyl 2-oxopropanoate, ethyl 3-methyl-2-oxabutanoate, 4,4-dimethyldihydrofurane-2,3-dione, ethyl phenylglyoxylate, and combinations thereof.

In some aspects of the N-vinylamine-containing polymer, the polymerization is initiated using a UV-LED light source having an emission wavelength of from about 300 nm to about 400 nm, or from about 350 nm to about 360 nm.

In other aspects of the vinylamine-containing polymer, the intensity of the UV-LED light source during polymerization is from about 55 μW/cm² to about 40000 μW/cm², or from about 250 μW/cm² to about 10000 μW/cm².

In other aspects of the vinylamine-containing polymer, the initial temperature of the gel polymerization reaction is from about −5° C. to about 50° C., or from about 0° C. to about 25° C.

In yet other aspects of the vinylamine-containing polymer, the temperature profile of the aqueous medium during polymerization is from about 0° C. to about 75° C. (see FIG. 1).

In some aspects of the vinylamine-containing polymer, the vinylamine-containing polymer has a molecular weight in the range of from about 5,000 Daltons to about 5,000,000 Daltons, or from about 100,000 Daltons to about 2,000,000 Daltons, or from about 250,000 Daltons to about 750,000 Daltons.

In other aspects of the vinylamine-containing polymer, the final water content of the N-vinylcarboxamide-containing polymer is from 0 wt. % to about 10 wt. %.

In some aspects of the vinylamine-containing polymer, the N-vinylcarboxamide monomer is selected from N-vinylformamide, N-vinyl-N-methylformamide, N-vinylacetamide, N-vinyl-N-methylacetamide, N-vinyl-N-ethylacetamide, N-vinylpropionamide and N-vinyl-N-methyl-propionamide, and N-vinylbutyramide.

In yet other aspects of the vinylamine-containing polymer, the N-vinylcarboxamide-containing polymer is a polymer or copolymer of N-vinylformamide.

In some aspects of the N-vinylamine-containing polymer, there can be one or more optional vinyl monomers chosen from acrylamide, methacrylamide, N-isopropylacrylamide, N-methylmethacrylamide, N-vinylpyrrolidone, acrylonitrile, vinyl acetate, vinyl chloride, styrene, quaternary ammonium salts of dimethylaminoethyl acrylate (DMAEA), quaternary ammonium salts of dimethylaminoethyl methacrylate (DMAEMA), diallyldimethylammonium chloride (DADMAC), acrylamidopropyltrimethyl ammonium chloride (APTAC), methacrylamidopropyltrimethyl ammonium chloride (MAPTAC); and/or one or more monomers from, acrylic acids, methacrylic acids, itaconic acids, crotonic acids, maleic acids, fumaric acids, 2-acrylamido 2-methylpropane sulfonic acids, vinyl sulfonic acids, vinyl phosphonic acids, allyl sulfonic acids, allyl phosphonic acids, styrene sulfonic acids, water-soluble salts of an alkali metal, water-soluble salts of an alkaline-earth metal, water-soluble salts of ammonium of these monomers, and combinations thereof.

In other aspects of the vinylamine-containing polymer, the dried composition of the N-vinylcarboxamide-containing polymer is in the form of granules, beads, powder, or a particulate form.

In some aspects, the vinylamine-containing polymer produced is added to a pulp suspension in an amount of from about 0.01 wt. % to about 5.0 wt. %, or from about 0.25 wt. % to about 4 wt. % based on the dry wt. of the pulp suspension.

In other aspects, the produced vinylamine-containing polymer is used as a coagulant, a flocculant, a retention agent, a dry strength aid, a dewatering agent, and/or a sizing agent in a papermaking processes.

It is to be appreciated that any or all of the components above (e.g. monomers, modifiers, etc.) may be prepared or otherwise obtained (e.g. from commercial sources). Moreover, such components and/or the reagents used to prepare the same may originate from traditional (e.g. fossil-based) sources, or instead may be bio-based, i.e., prepared using biological methods and/or from products of such methods. In some embodiments, the method utilizes all bio-based components in the preparation of the vinylamine containing polymers. In other embodiments, at least a portion of a component is bio-based.

The embodiments of the invention are defined in the following Examples. It should be understood that these Examples are given by way of illustration only. Thus, various modifications of the present invention in addition to those shown and described herein will be apparent to those skilled in the art from the foregoing description. Although the method has been described with reference to particular means, materials, and embodiments, it is to be understood that the method is not limited to the particulars disclosed and extends to all equivalents within the scope of the appended claims.

### EXAMPLES

The following examples demonstrate the vinylamine-containing polymers of the current composition provided enhanced drainage performance when the compositions are used as paper making additives. These examples and the data presented below better illustrate the benefits of the current composition and are not meant to be limiting.

### Example-1: Synthesis of Poly(N-Vinylformamide) Homopolymer A

In the following example, a 50 wt. % VFA solution was prepared by adding 250 grams of Vinylformamide and 245 grams distilled water to a 1-liter (L) beaker and the pH adjusted to 6 with sulfuric acid (1 wt. %) under stirring. A solution of 0.375 g HMPP (2-hydroxy-2-methylpropiophenone, 750 ppm) was mixed with 3 gram of polyethylene glycol (PEG 300) and added into the 50 wt. % VFA solution. This mixture was deoxygenated with nitrogen for 15 minutes while the mixture was held at 20° C. At this point, a UV-LED with a narrow emission spectrum at 365 nm was used to trigger initiator decomposition. The light intensity was regulated using a power supply and monitored using a UV-AB meter (General, UV513AB, Digital UV AB Light Meter). A plastic bucket is placed beneath the LED source and polymerization is started using a light source intensity of 3.5 mW/cm² until the temperature reached 70° C. The intensity is then manually regulated to hold the temperature at about 70° C. After 2.5 hours the intensity of the LED was again set at 3.5 mW/cm², and after 5 minutes adjusted to 32 mW/cm² for an additional 2 hours to reduce residual monomers. The temperature profile during polymerization can be seen in FIG. 1. The resulting polymer gel was minced using a meat grinder with perforated disks at 3-6 mm in diameter and dried at 70° C. for 45 minutes, and 60° C. for an additional 30 minutes in a fluid bed dryer with 70% air flow. A dry powder was obtained and milled at 20000 revolutions-per-minute (rpm) and sieved to collect a dry product having a particle size of less than 2000 micron (μm).

### Example-2: Synthesis of Poly(N-Vinylformamide) Homopolymer B

The polymerization process described in example 1 was followed, except following changes were made. A solution of 0.75 g HMPP (2-hydroxy-2-methylpropiophenone, 1500 ppm) was mixed with 3 gram of polyethylene glycol (PEG 300) and added into the 50 wt. % VFA solution. The polymerization is started using a light source intensity of 32 mW/cm² until the temperature reached 80° C. The intensity is then manually regulated to hold the temperature at about 80° C. After 2 hours the intensity of the LED was again set at 3.5 mW/cm2, and after 5 minutes adjusted to 32 mW/cm2 for an additional 2 hours to reduce residual monomers.

### Example-3: Synthesis of Poly(N-Vinylformamide) Homopolymer C

The polymerization process described in example 1 was followed, except the initial reaction mixture was deoxygenated with nitrogen for 15 minutes while the mixture was cooled to 0° C. via a dry ice bath.

### Example-4: Synthesis of Poly(N-Vinylformamide) Homopolymer D

The polymerization process described in example 1 was followed, but a solution of 0.75 g HMPP (2-hydroxy-2-methylpropiophenone, 1500 ppm) was mixed with 3 gram polyethylene glycol (PEG 300) and added into the 50 wt. % VFA solution.

### Example-5: Synthesis of Poly(N-Vinylformamide) Homopolymer E

The polymerization process described in example 1 was followed but an additional 0.375 g of V-50 was used (available from Fujifilm Wako chemicals, USA). The polymerization is started using a light source intensity of 3.5 mW/cm² until the temperature reached 50° C. The intensity is then manually regulated to hold the temperature at about 50° C. After 2 hours the intensity of the LED was again set at 3.5 mW/cm2 and then regulated to reach peak temperature. After 80 minutes is again adjusted to 3.5 mW/cm2 and after 5 minutes to 32 mW/cm2 for an additional 2 hours to reduce residual monomers.

### Example-6—Hydrolysis of Polymer B to Produce PVAM A-h50

A 250 mL reaction vessel fitted with a condenser, pH and temperature probes, a temperature-controlled heating setup, an addition funnel, and a mechanical stirrer was used. To the reactor, 6.25 grams of Polymer A, 0.15 grams of SMBS, and 135 grams of water were added and heated to a temperature of 80° C. To this mixture, 1.93 grams of NaOH was added. The temperature was kept stable at 80° C. for 220 minutes. Subsequently, the reaction was cooled and neutralized to pH 8 using concentrated hydrochloric acid. The process results in a viscous polyvinylamine polymer, labelled as Polymer A-h50.

### Example-7—Hydrolysis of Product C to Produce PVAM B-h50

Same method as in example-6 was used except the Polymer B was used instead of Polymer B. The process results in a viscous polyvinylamine polymer, labeled as Polymer B-h50.

### Polymer Evaluation

The molecular weights of the PVAM polymers were compared using reduced specific viscosity (RSV). The RSV was determined at 0.20 wt. % in 1 M ammonium chloride using a MINIPV®-HX viscometer available from Cannon® instrument company. A higher RSV indicates higher molecular weight.

The gel polymerization allows for synthesis of higher molecular weight PVFA polymers compared to PVFA polymers synthesized by conventional solution polymerization. After hydrolysis higher molecular weight PVFA results in higher molecular weight PVAM. The RSV for a polyvinylamine resin (50% hydrolyzed) available from Solenis LLC, was used as a comparative sample (Comparative PVAM-1) and the hydrolyzed polymers Polymer A-h50 and Polymer B-h50, used for further performance evaluation are summarized in Table 1.

TABLE 1
Results from RSV measurements.

| Polymer | RSV |
|---|---|
| Comparative PVAM-1 | 1.9 |
| Polymer A-h50 | 4.4 |
| Polymer B-h50 | 3.6 |

### Evaluation of Drainage Performance

The PVAM polymers were compared for their drainage performance utilizing a Dynamic Drainage Analyzer, test equipment available from AB Akribi Kemikonsulter Sundsvall, Sweden. A 750 milliliter (ml) sample volume at 0.9% consistency and a 0.500 mm opening/0.25 mm thread (32-mesh screen) were used in these tests. The test device applied a 300-mbar vacuum to the bottom of the separation medium and the time between the application of vacuum and the vacuum break point electronically measured, i.e. the time at which the air/water interface passes through the thickening fiber mat. Drainage testing was performed using paper pulp that was 100% American OCC recycled medium with 50 parts-per-million (ppm) hardness, 25 ppm alkalinity, 2.5% GPC D15F oxidized starch (Grain Processing Corp., Muscatine, Iowa) and about 2000-2100 μS/cm conductivity. The system pH was 7.0 and the pulp freeness was about 350-400 CSF for the recycled medium. A drainage index (DI) can be calculated as the drainage time for the control system with no additives divided by the time it takes for the system with additives. Therefore, a higher DI demonstrates an improvement in drainage as indicated by the results shown in Table 2.

TABLE 2
Drainage Index Results

| Wt % | Drainage Index | | |
|---|---|---|---|
| Dosage | Comparative PVAM-1 | Polymer A-h50 | Polymer B-h50 |
| 0.00 | 100.0 | 100.0 | 100.0 |
| 0.025 | 100.7 | 105.0 | 102.6 |
| 0.05 | 114.8 | 138.0 | 122.4 |
| 0.1 | 144.6 | 229.3 | 195.1 |
| 0.2 | 192.4 | 365.8 | 304.3 |

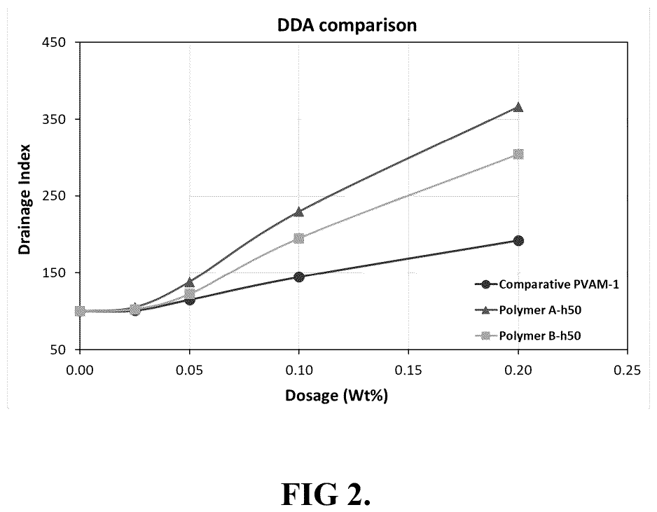

The drainage performance improves with an increase in molecular weight. The PVAM Polymer A-h50 and B-h50, from examples provided better drainage performance compared to Comparative PVAM-1. See also FIG. 2.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

We claim:

1. A method of producing a composition of a N-vinylcarboxamide-containing polymer using photoinitiated gel polymerization, wherein the method comprises:
performing a photoinitiated gel polymerization of an aqueous phase using initiators that are only sensitive to UV light and wherein the suspension contains:
a) one or more N-vinylcarboxamide monomer(s) of Formula I, 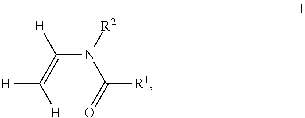
wherein R¹ and R², independently of one another, are H or C₁ to C₆ alkyl; and
b) optionally, one or more vinyl monomer(s) which are different from Formula I; and
removing water from the polymerized product.

2. The method according to claim 1, wherein the photoinitiator can be chosen from 2-hydroxy-2-methylpropiophenone, 2,2′-azobis-(2-methyl-propionamidin)-dihydrochloride, 2,2′-azobis(2-methylpropionitrile), 2,2′-azobis[2-(2-imidazolin-2-yl)propane]dihydrochloride or comparable azo initiators, 2,2-dimethoxy-2-phenylacetophenone, alpha-ketoglutaric acid, camphorquinone, (1-hydroxycyclohexyl)-phenyl ketone, α-hydroxy-4-(2-hydroxyethoxy)-α-methylpropiophenone, ethyl 2-oxopropanoate, ethyl 3-methyl-2-oxabutanoate, 4,4-dimethyldihydrofurane-2,3-dione, ethyl phenylglyoxylate, and combinations thereof.

3. The method according to claim 2, wherein the initiator is 2-hydroxy-2-methylpropiophenone.

4. The method according to claim 1, wherein the gel polymerization is carried out using one or more radical co-initiators.

5. The method according to claim 1, wherein the polymerization is initiated using a UV-LED light source having an emission wavelength of from about 300 nm to about 400 nm, or from about 350 nm to about 360 nm.

6. The method according to claim 1, wherein the intensity of the UV-LED light source is from about 55 μW/cm² to about 40000 μW/cm², or from about 250 μW/cm² to about 10000 μW/cm².

7. The method according to claim 1, wherein the initial temperature of the gel polymerization reaction is from about −5° C. to about 50° C., or from about 0° C. to about 25° C.

8. The method according to claim 1, wherein the temperature of the aqueous medium during polymerization is from about 0° C. to about 90° C., or from about 0° C. to about 70° C., or from about 50° C. to about 70° C.

9. The method according to claim 1, wherein the N-vinylcarboxamide-containing polymer has a molecular weight in the range of from about 5,000 Daltons to about 5,000,000 Daltons, or from about 100,000 Daltons to about 2,000,000 Daltons, or from about 250,000 Daltons to about 750,000 Daltons.

10. The method according to claim 1, wherein the water is removed or partially removed from the polymerized product through drying from 50° C. to about 150° C., or from 60° C. to 80° C., for 20 to 300 min, either via conventional drying or air drying.

11. The method according to claim 1, wherein the final water content of the N-vinylcarboxamide-containing polymer is from 0 wt. % to about 15 wt. %, or from about 0 wt. % to about 10 wt. %.

12. The method according to claim 1, wherein the N-vinylcarboxamide monomer is selected from N-vinylformamide, N-vinyl-N-methylformamide, N-vinylacetamide, N-vinyl-N-methylacetamide, N-vinyl-N-ethylacetamide, N-vinylpropionamide and N-vinyl-N-methyl-propionamide, and N-vinylbutyramide.

13. The method according to claim 12, wherein the N-vinylcarboxamide-containing polymer is a polymer or copolymer of N-vinylformamide.

14. The method according to claim 1, wherein the one or more of the optional vinyl monomers are selected from acrylamide, methacrylamide, N-isopropylacrylamide, N-methylmethacrylamide, N-vinylpyrrolidone, acrylonitrile, vinyl acetate, vinyl chloride, styrene, quaternary ammonium salts of dimethylaminoethyl acrylate (DMAEA), quaternary ammonium salts of dimethylaminoethyl methacrylate (DMAEMA), diallyldimethylammonium chloride (DADMAC), acrylamidopropyltrimethyl ammonium chloride (APTAC), methacrylamidopropyltrimethyl ammonium chloride (MAPTAC); and/or one or more monomers from, acrylic acids, methacrylic acids, itaconic acids, crotonic acids, maleic acids, fumaric acids, 2-acrylamido 2-methylpropane sulfonic acids, vinyl sulfonic acids, vinyl phosphonic acids, allyl sulfonic acids, allyl phosphonic acids, styrene sulfonic acids, water-soluble salts of an alkali metal, water-soluble salts of an alkaline-earth metal, water-soluble salts of ammonium of these monomers, and combinations thereof.

15. The method according to claim 1, wherein the composition of N-vinylcarboxamide-containing polymer is in the form of a gel, granules, beads, powder, or particulate form.

16. The method according to claim 1, wherein the granules, beads, powder, or particulates, are hydrolyzed to a vinylamine containing polymer in an aqueous solution of base(s) or acid(s).

17. An N-vinylamine-containing polymer produced according to claim 1.

18. The N-vinylamine-containing polymer according to claim 17, wherein the vinylamine-containing polymer is added to a pulp suspension in an amount of from about 0.01 wt. % to about 5.0 wt. %, or from about 0.25 wt. % to about 4 wt. % based on the dry wt. of the pulp suspension.

19. The N-vinylamine-containing polymer according to claim 17, wherein the vinylamine-containing polymer is used as a coagulant, a flocculant, a retention agent, a dry strength aid, a dewatering agent, and/or a sizing agent in a papermaking processes.
